(19) United States
(12) Patent Application Publication
(10) Pub. No.: US 2013/0153055 A1
(43) Pub. Date: Jun. 20, 2013

(54) Vehicle Running Board having Integral Water Tank and Pumping System

(71) Applicant: Ruben E. Gaffoglio, Fountain Valley, CA (US)

(72) Inventor: Ruben E. Gaffoglio, Fountain Valley, CA (US)

(21) Appl. No.: 13/554,249

(22) Filed: Jul. 20, 2012

Related U.S. Application Data
(60) Provisional application No. 61/510,350, filed on Jul. 21, 2011.

(51) Int. Cl. B60R 11/00

(52) U.S. Cl. CPC B60R 11/00
USPC 137/355; 224/545

(57) ABSTRACT

A Vehicle Running Board having Integral Water Tank and Pumping System. The device functions as a vehicle running board, and is aesthetically appealing by integrating with the overall body design. In addition, the device has a hollow interior compartment within which liquid, such as water, can be stored. Furthermore, the device includes an integrated, internal pump for providing a pressurized liquid source for utility purposes. One or more ends of the running board compartment may have a see-through window in order to visually verify the liquid level within the interior compartment. Non-skid material may be adhered or embossed on one or more top surfaces of the device in order to aid in safe ingress to and egress from the vehicle.

This application is filed within one year of, and claims priority to Provisional Application Ser. No. 61/510,350, filed Jul. 21, 2011.

### BACKGROUND OF THE INVENTION

1. Field of the Invention

This invention relates generally to vehicle accessories and, more specifically, to a Vehicle Running Board having Integral Water Tank and Pumping System.

2. Description of Related Art

Auxiliary water tanks for motor vehicles have been experimented with by numerous inventors over the years. These mobile water supplies were generally created for one of two purposes—either to provide the vehicle with a portable washing system to wash the host vehicle or other vehicles, or else as a portable water source for human and/or vehicle consumption.

Five patents have been uncovered that are directed towards systems of the first type. Oberdorfer, U.S. Pat. No. 3,599,869 discloses a “Car Washing Apparatus Adapted for Mounting on the Vehicle to be Washed.” The Oberdorfer device is located within the engine compartment of the vehicle, and requires the vehicle's engine to create the force necessary to pump the wash water. Palmer, U.S. Pat. No. 4,158,248 also provides a vehicle-mounted washing system. Like Oberdorfer, the Palmer “Mobile Cleaning Unit” is located in the engine compartment (except perhaps for the fluid reservoir, which can be located elsewhere in the vehicle), and has its water pressure created by the vehicle's engine. The “Car-equipped with Self-washing Device” described by Shin in U.S. Patent Application No. US2004/0079402 is also located within the engine compartment, and utilizes the vehicle engine for generating water pressure. A. J. Torrey, U.S. Pat. No. 3,372,875 describes a “Combination Cleaning Fluid Nozzle and Hydraulically Operated Hopper for Refuse Collecting Apparatus,” which uses the engine drive train (a takeoff shaft) to drive a motorized to pump to provide pressurized water for washing a garbage truck hopper. Finally, A. Casale (U.S. Pat. No. 3,317,142) describes a vehicle-mounted, portable canvash system that, like the previously-mentioned-systems, is contained (at least in part) within the vehicle engine compartment, and obtains water pressure from the engine power takeoff shaft.

While these prior art vehicle cleaning systems seem to be functional for their intended purpose of providing pressurized wash water in great quantities, they all suffer from the following drawbacks: (1) they are large, complex, integrated systems that are not suitable for after-market installation into an existing vehicle; (2) they do not provide any aesthetic or ergonomic benefit to the vehicle's driver or passengers; and (3) they are prohibitively expensive for wide-spread usefulness.

Examples of the second variety of systems for vehicle-mounted portable water supplies include: Armstrong, U.S. Pat. No. 5,590,819 for “Vehicle-mountable Auxiliary Water Tank” is, essentially, a cylindrical tank mounted to the vehicle's frame. It is incapable of producing pressurized water, and does not provide additional ergonomic benefit to the driver/passengers. J. E. Robison, U.S. Pat. No. 1,411,378 for “Water or Other Liquid Holding Tank for Automobiles,” is very similar to the Armstrong device, but it is positioned beneath the vehicle's running boards. While Robison fails to provide pressurized water, it does provide an aesthetic and ergonomic advantage over the Armstrong device. Finally, S. H. Love, U.S. Pat. No. 1,351,336 discloses a “Emergency Tank for Automobiles” that is functionally identical to Robison.

None of these prior art devices and systems provides an ergonomic and aesthetically pleasing pressurized water source for vehicles that is cost-effective to be added to as an accessory to an existing vehicle.

### SUMMARY OF THE INVENTION

In light of the aforementioned problems associated with the prior devices and systems, it is an object of the present invention to provide a Vehicle Running Board having Integral Water Tank and Pumping System. The device should function as a vehicle running board, and be aesthetically appealing by integrating with the overall body design. In addition, the device should have a hollow interior compartment within which liquid, such as water, can be stored. Furthermore, the device should include an integrated, internal pump for providing a pressurized liquid source for utility purposes. One or more ends of the running board compartment may have a see-through window in order to visually verify the liquid level to within the interior compartment. Non-skid material may be adhered or embossed on one or more top surfaces of the device in order to aid in safe ingress to and egress from the vehicle.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a perspective view of a conventional motor vehicle;

FIGS. 2A and 2B are perspective and partial top views of a preferred embodiment of the running board having integral water tank and pumping system of the present invention;

FIGS. 3A and 3B are perspective and end views, respectively, of the system of FIGS. 2A and 2B;

FIG. 4 is a cutaway side view of the system of FIGS. 2A, 2B and 3; and

FIG. 5 is a perspective view of the vehicle of FIG. 1 having an embodiment of the device of FIGS. 2A-4 installed thereon.

### DETAILED DESCRIPTION OF THE PREFERRED EMBODIMENTS

The following description is provided to enable any person skilled in the art to make and use the invention and sets forth the best modes contemplated by the inventor of carrying out his invention. Varbus modifications, however, will remain readily apparent to those skilled in the art, since the generic principles of the present invention have been defined herein specifically to provide a Vehicle Running Board having Integral Water Tank and Pumping System.

As discussed above, the device and system of the present invention is designed to fill the gap within the benefits provided by the prior devices and systems. It can be installed by an original equipment manufacturer, or as an after-market accessory added to a vehicle. It provides a low-cost source of water (or other fluid) that is always available to the vehicle driver that can be used for drinking, cooking, washing, among others. A particularly unique and valuable feature of the device is that there is an internal pumping system so that the liquid can be more easily dispensed for use.

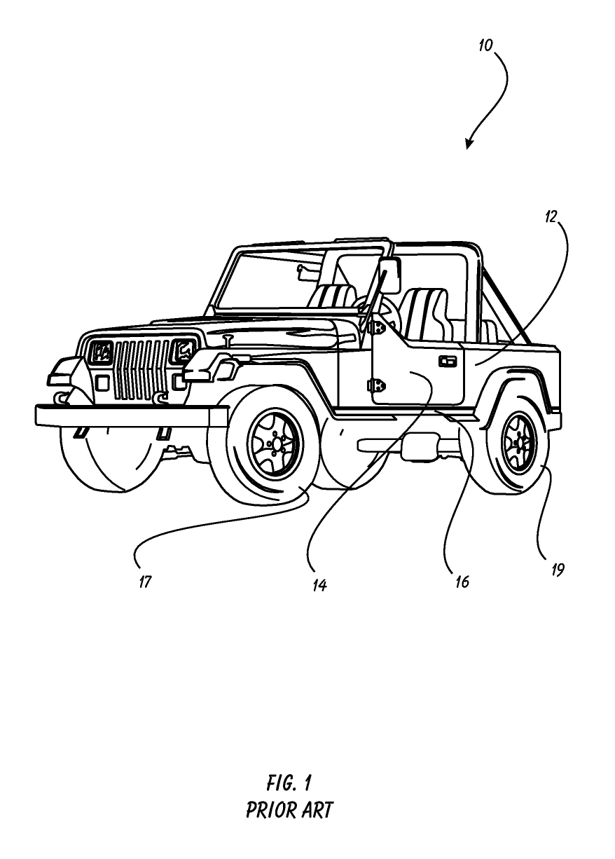

The present invention can best be understood by initial consideration of FIG. 1. FIG. 1 is a perspective view of a conventional motor vehicle 10. The exemplary vehicle in this depiction is a two-door, off-road capable car. This vehicle type was chosen because of its readiness for off-road, remote use, as well as for the propensity for its owners to “accessorize” their vehicles with after-market components that provide additional functionality and perceived style as compared to the original equipment vehicle. Owners of four-door off-road vehicles and pickup trucks are also expected to be interested in the device and system of the present invention, and as such a version of the instant invention is available in both a two-door version and a four-door version. The distinctions between the two will be discussed below in the context of the overall discussion of the device.

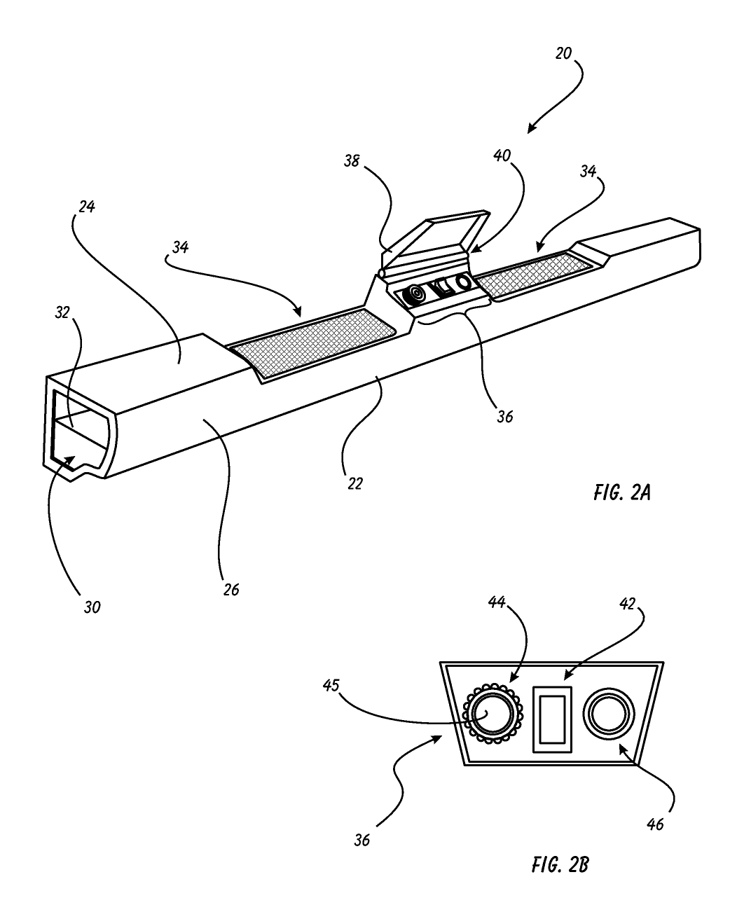

For the purpose of future reference herein, the elements of the vehicle 10 identified herein are the body 12, the door 14 (of which there are two in this particular vehicle), and the sill 16 (which is the portion of the body 12 and vehicle frame located directly below the door 14, and at times extending nearly to the front and rear wheels 17 and 19). Turning to FIGS. 2A and 2B, we can begin to examine the details of the device and system of the instant invention.

FIGS. 2A and 2B are perspective and partial top views of a preferred embodiment of the running board having integral water tank and pumping system 20 of the present invention. The device 20 is in large part a custom-shaped hollow housing 22 that is shaped as a running board, but that also functions as a water reservoir and pumping system. The housing 22 is preferably formed from aluminum or fiberglass, although other manufacturing techniques and/or materials may be employed, depending upon the particular characteristics that are desired.

The housing 22 is defined by an outside wall 26, a top wall 24, an inside wall (not shown), and a pair of end walls 30. In this version, one or both of the end walls 30 are fitted with a section of clear plastic or glass that allows the fluid level 32 to be seen from outside of the device 20. There may or may not be a plurality of “tick marks” on the window formed in the end wall 30 to aid in the estimation of the remaining liquid volume remaining within the housing 22.

The top wall 24 of the housing 22 has one or more step portions 34 formed in it. These step portions 34 are intended to provide a location for the driver or passengers of the vehicle to step on when entering or exiting the vehicle—i.e. to provide the functionality of a conventional running board.

In the center portion of the top wall 24 of the housing 22 (in between the two step portions 34 in this version), a lid 38 can be lifted to reveal the operations panel 36. The lid 38 is attached to the housing 22 by a hinge 40. In other versions, the lid 38 may be omitted, or alternatively the lid 38 could be simply snapped off of the housing 22 to reveal the operations panel 36.

The depicted version is designed for a four-door vehicle (two doors per side of the vehicle), and therefore it has a pair of step portions 34 formed into its top wall 24. It is expected that the step portions 34 will each line up with a vehicle door when the device 20 is attached below the sill of the vehicle. The hardware necessary to attach the device 20 to the vehicle will also change from vehicle to vehicle. Consequently, it would be desirable that each particular vehicle or vehicle type have a running board tank system 20 that is specifically designed to fit and be compatible with the vehicle. This will ensure that the device 20 will fit the particular vehicle, and further that it will provide the optimum aesthetic and ergonomic benefits to the owner.

The operations panel 36 contains the operational components that distinguishes the device 20 of the present invention from the prior art. There is a fill port 44, which is where the user directs the flow of the water or other liquid used to fill the housing 22. Here, a removable cap 45 is in place to seal the fill port 44 against leakage or contamination. A dispense port 46 is also provided on the operations panel 36. This port 46 may or may not also have a removable cap, although it is much less likely to be necessary because access to the internal chamber of the housing 22 through the dispense port 46 if blocked by an internal pumping system.

The dispense port 46 is preferably designed to threadedly interface with a conventional garden hose so that it is very easy to attach a common garden hose without the need for additional attachments or accessories. Other adapters and/or interface devices may to be utilized if other dispense options are desired.

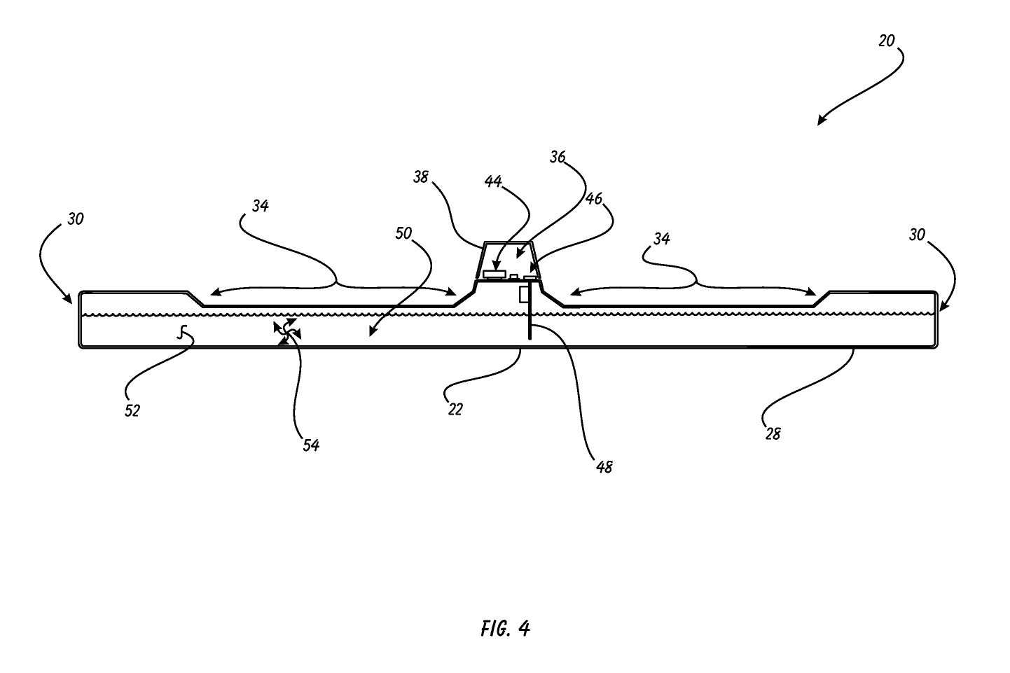

The pump control switch 42 is a conventional electric switch that turns the internal pumping system on and off. In order to prevent the pump from being left on, it is preferable that the switch 42 be of the “momentary” or “non-latching” type so that the user must manually keep the switch 42 depressed in order to keep the pump running. In other versions, there may be a manual pump option, where the user is able to manually operate a lever, pedal or the like in order to pump the fluid out through the dispense port 46. In other versions, the operations panel 36 may be located elsewhere along the housing 22, such as at one end, or somewhere in between. For a four-door vehicle, it has been determined that a centralized location, between the two step portions 34, is best for both panel 36 location, as well as suction tube (see FIG. 4) location.

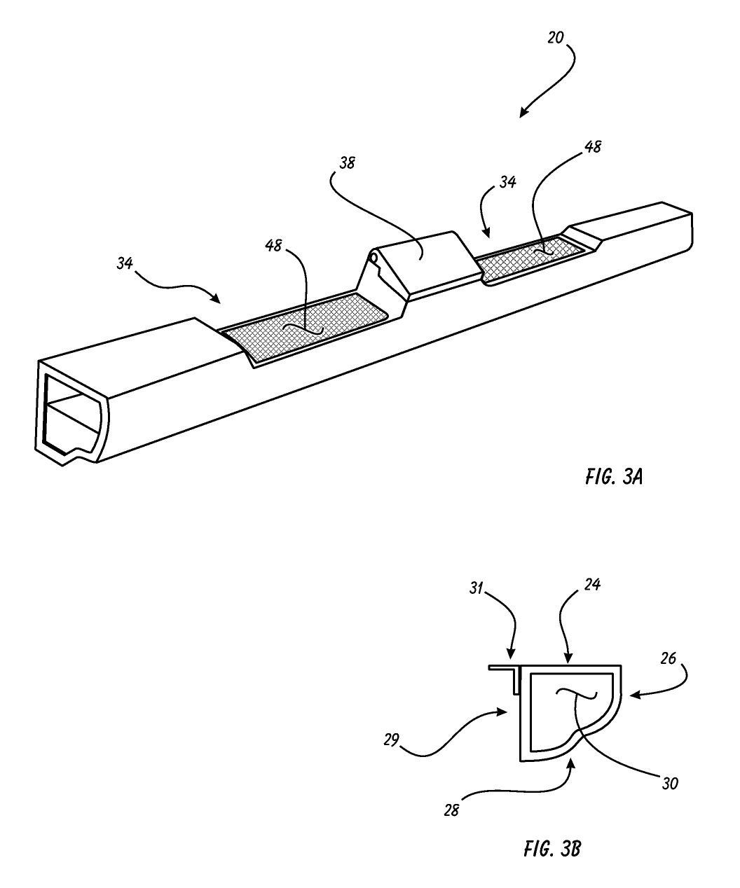

FIG. 3B is an additional perspective view of the system 20 of FIGS. 2A and 2B. In this view, the lid 38 has been placed in the closed position so that the running board pumping system 20 exhibits a very pleasing aesthetic appearance, and also to protect the operations panel from road grime, damage and tampering. The two step portions 34, in this version, have a non-skid material 48 applied to their upper surface in order to provide better traction for anyone using the step portions 34 (i.e. to step on). FIG. 3B is an end view of the system of FIGS. 2A and 2B. Here, we can see that in addition to the top, outside and bottom walls (24, 26, 28), there is also an inside wall 29. The inside wall 29 is intended to face the underside of the vehicle, and also is where one or more attachment brackets 31 extend. The attachment brackets 31 are designed to firmly attach the system 20 to the frame of the vehicle, essentially in the same manner as the original equipment running boards attach to the vehicle. If we now turn to FIG. 4, we can examine the internal components of the device 20.

FIG. 4 is a cutaway side view of the system 20 of FIGS. 2A, 2B and 3. The housing 22 is a sealed vessel that creates a clean, leak-free liquid chamber 54 for water or other liquid 52. As shown, each step portion 34 is molded into the top wall of the housing 22.

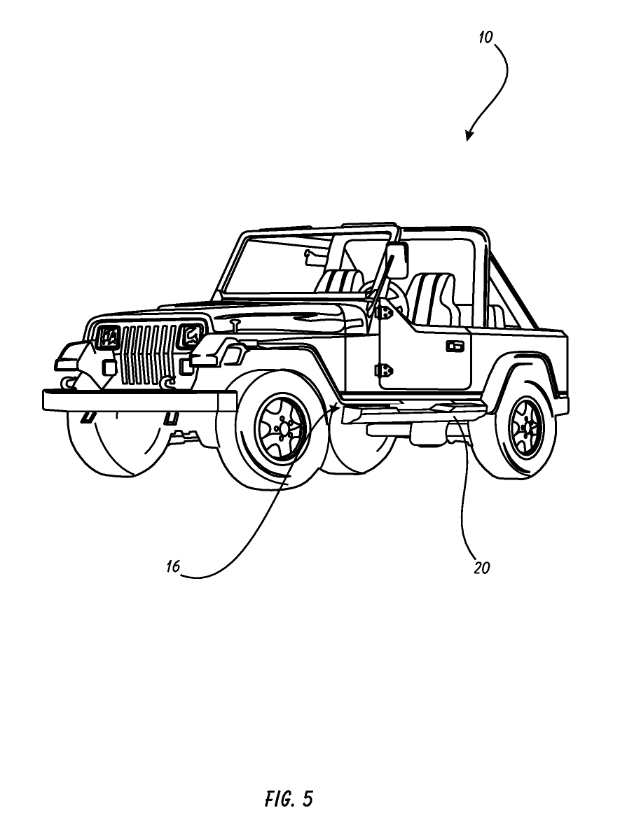

A suction tube 48 is located so that its suction end (on the bottom here) is near the center area of the liquid chamber 54 so that it will be in communication with the liquid 52 even if the vehicle is not parked on a completely level surface. A suction pump 50 sucks liquid up through the suction tube 48 and dispenses it through the dispense port 46. The pump 50 could be an electrically-powered pump receiving its power either from the vehicle's electrical system, from an internal (to the device) battery, or even from a photovoltaic power source. Power is applied to, and removed from the pump 50 by the pump control switch located on the operations panel 36. Alternatively, the pump 50 could be operated by manual pumping force created by the user (as discussed previously). The manual pump actuator may or may not be located adjacent to the fill and dispense ports 44 and 46. A view of an installed system 20 can be seen in FIG. 5.

FIG. 5 is a perspective view of the vehicle 10 of FIG. 1 having an embodiment of the device 20 of FIGS. 2A-4 installed thereon. As discussed previously, this is a two-door vehicle 10, and therefore there is only a single step portion formed in the top wall of the housing. Also, the operations panel is not necessarily located in the exact center of the housing.

The device 20 is mounted to the vehicle 10 frame and/or body so that it is directly below the sill 16. In this location, it is very convenient to the user for filling and pumping liquid, but also doubles as a step to assist the driver and passengers in embarking and debarking from the vehicle 10.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A running board attachment for a vehicle, comprising:
an elongate housing defining a hollow internal chamber, said housing having a top wall, an outside wall, a bottom wall and an inside wall;
one or more attachment brackets extending from said inside wall; and
at least one step portion disposed on said top wall.

2. The attachment of claim 1, further comprising a pump associated with said housing, said pump configured to transport contents of said hollow internal chamber out through a dispense port formed on said housing in response to electrical power being engaged thereto.

3. The attachment of claim 2, further comprising:
a fill port disposed on said housing, said fill port providing access from outside said housing into said internal chamber; and
a fill port cap attachable to seal said fill port.

4. The attachment of claim 3, wherein said housing further comprises a pair of opposing end walls, at least one of said end walls having a transparent or translucent portion.

5. The attachment of claim 4, further comprising an operations panel formed in said housing, said operations panel having said dispense port, said fill port and a pump control switch for energizing and de-energizing said electrical power to said pump.

6. The attachment of claim 5, wherein said step portions are inset below an upper surface of the rest of said top wall.

7. The attachment of claim 6, wherein said step portions further comprise a rough surface texture.

8. The attachment of claim 7, wherein said operations panel is covered by a hinged lid, said lid top surface defining a plane that is in spaced relation to a plane defined by the top surface of said step portions.

9. An auxiliary liquid storage assembly for a vehicle, comprising:
an elongate housing defining a hollow internal chamber, said housing having a top wall, an outside wall, a bottom wall and an inside wall;
a pump within said chamber, said pump configured to transport contents of said hollow internal chamber out through a dispense port formed on said housing in response to the application of electrical power to said pump;
one or more attachment brackets extending from said inside wall; and
at least one step portion disposed on said top wall.

10. The assembly of claim 9, wherein said housing further comprises a pair of opposing end walls, at least one of said end walls having a transparent or translucent portion.

11. The assembly of claim 9, wherein said step portions are inset below an upper surface of the rest of said top wall.

12. The assembly of claim 11, wherein said step portions further comprise a rough surface texture.

13. The assembly of claim 9, further comprising:
a fill port disposed on said housing, said fill port providing access from outside said housing into said internal chamber; and
a fill port cap attachable to seal said fill port.

14. The assembly of claim 13, further comprising an operations panel formed in said housing, said operations panel having said dispense port, said fill port and a pump control switch for energizing and de-energizing said electrical power to said pump.

15. The assembly of claim 14, wherein said operations panel is covered by a hinged lid, said lid top surface defining a plane that is in spaced relation to a plane defined by the top surface of said step portions.

16. An auxiliary water tank assembly for a vehicle, said vehicle defined by driver and passenger doors and door sills beneath said doors, the assembly comprising:
an elongate housing defining a hollow internal chamber, said housing having a top wall, an outside wall, a bottom wall and an inside wall;
a pump within said chamber, said pump configured to transport contents of said hollow internal chamber out through a dispense port formed on said housing in response to the application of electrical power to said pump;
a pump control switch for operably activating or de-activating said application of electrical power to said pump;
a fill port disposed on said housing, said fill port providing access from outside said housing into said internal chamber for introducing fluid therethrough;
one or more attachment brackets extending from said inside wall, said brackets designed to attach to said housing to said vehicle adjacent to one of said door sills; and
at least one step portion formed as a recessed portion of said top wall.

17. The assembly of claim 16, wherein said step portions further comprise a rough surface texture.

18. The assembly of claim 16, wherein each said housing further comprises a pair of opposing end walls, at least one of said end walls having a transparent or translucent portion.

19. The assembly of claim 18, further comprising an operations panel formed in said housing, said operations panel having said dispense port, said fill port, a pump control switch for energizing and de-energizing said electrical power to said pump, said assembly further having a hinged lid for covering said operations panel.

20. A pair of the water tank assemblies of claim 16, one said assembly being left-handed so as to be configured to attach to said vehicle adjacent to said driver door sill and one said assembly being right-handed so as to be configured to attach to said vehicle adjacent to said passenger door sill.
